(19) United States
(12) Patent Application Publication
(10) Pub. No.: US 2014/0042137 A1
(43) Pub. Date: Feb. 13, 2014

(54) SYSTEM AND METHOD OF EXPORTING OR USING WELDING SEQUENCER DATA FOR EXTERNAL SYSTEMS

(71) Applicants: Joseph Daniel, Streetsboro, OH (US); Edward Enyedy, Eastlake, OH (US); Judah Henry, Geneva, OH (US)

(72) Inventors: Joseph Daniel, Streetsboro, OH (US); Edward Enyedy, Eastlake, OH (US); Judah Henry, Geneva, OH (US)

(73) Assignee: LINCOLN GLOBAL, INC., CITY OF INDUSTRY, CA (US)

(21) Appl. No.: 13/803,077

(22) Filed: Mar. 14, 2013

Related U.S. Application Data
(63) Continuation-in-part of application No. 11/613,652, filed on Dec. 20, 2006.

(51) Int. Cl. B23K 9/095

(52) U.S. Cl. CPC B23K 9/0953
USPC 219/130.5

(57) ABSTRACT

The invention described herein generally pertains to a system and method for collecting one or more welding parameters or a weld time during creation of one or more welds using a welding sequence. The one or more welding parameters and/or weld time for each welding sequence is utilized to determine an estimation of consumable depletion for a welding work cell and/or a repair/service to perform on equipment within the welding work cell. Furthermore, the weld time and/or welding parameters can be utilized to manage inventory for a plurality of welding work cells within a welding environment. Other embodiments provided track a cost for a performance of a weld with a welding sequence as well as identifying a workpiece to communicate information related to the one or more welds used for assembly.

### CROSS-REFERENCE TO RELATED APPLICATIONS

This application is a continuation-in-part of U.S. application Ser. No. 11/613,652, filed Dec. 20, 2006, and entitled “WELDING JOB SEQUENCER.” The entirety of the aforementioned application is incorporated herein by reference.

### TECHNICAL FIELD

Devices, systems, and methods consistent with the invention relate to welding work cells.

### BACKGROUND OF THE INVENTION

In the related art, work cells are used to produce welds or welded parts. There are at least two broad categories of work cells, including robotic work cells and semi-automatic work cells.

In robotic work cells, the scheduling and performing of welding operations is largely automated, with little operator involvement. Thus, these cells generally have a relatively low labor cost and a relatively high productivity. However, their repeating operations cannot easily adapt to varying welding conditions and/or sequences.

In contrast, semi-automatic work cells (i.e., work cells involving at least some operator welding) generally provide less automation vis-à-vis robotic work cells, and accordingly have a relatively higher labor cost and a relatively lower productivity. Nevertheless, there are many instances where using a semi-automatic welding work cell can actually be advantageous over robotic work cells. For example, a semi-automatic welding work cell can more easily adapt to varying welding conditions and/or sequences.

Unfortunately, when welding more complex assemblies in related art semi-automatic work cells, multiple different welding schedules are often required for different types of welds on different parts of an assembly. In many systems, when a different welding schedule must be utilized, the operator is required to stop welding operations and manually adjust the output of the semi-automatic equipment according to the new schedule. In some other systems, this manual adjustment is eliminated by storing particular schedules in the work cell. Nevertheless, even in such systems, the operator still needs to cease welding operations and push a button to select the new welding schedule before he may continue welding.

Neither of these practices for setting a different welding schedule is particularly efficient. Thus, in practice, the number of welding schedules used in a semi-automatic work cell is often reduced in order to eliminate the need for constant adjustment of the output of the semi-automatic equipment. While this reduction of welding schedules makes the overall operation easier for the welder, the forced simplification of this approach can lead to reduced productivity and lower overall quality.

Additionally, when abiding by strict quality control specifications, it is sometimes necessary to perform welds in a specific sequence, verify that each weld is performed with a given set of conditions, and monitor the output of the equipment during the welding operations. In a robotic work cell, these requirements are easily fulfilled. However, in a semi-automatic work cell, these requirements are susceptible to human error, since the operator must keep track of all of these aspects in addition to performing the welding operations themselves.

An illustrative example of the above problems is shown in the related art semi-automatic welding method diagrammatically represented in FIG. 1. In this method, each of the various scheduling, sequencing, inspection and welding operations are organized and performed by the operator (i.e., the welder) himself. Specifically, the operator begins the welding job at operation 10. Then, the operator sets up the welding equipment according to schedule A, at operation 20. Next, the operator performs weld #1, weld #2, and weld #3 using welding schedule A at operations 22, 24 and 26. Then, the operator stops welding operations and sets up the welding equipment according to schedule B at operation 30. Next, the operator performs weld #4 using welding schedule B at operation 32. Then, the operator checks the dimensions of the assembly at operation 40, and sets up the welding equipment according to schedule C at operation 50. Next, the operator performs weld #5 and weld #6 using welding schedule C at operations 52 and 54. After the welding operations are completed, the operator visually inspects the welded assembly at operation 60, and completes the welding job at operation 70.

Clearly, the method shown in FIG. 1 depends on the operator to correctly follow the predefined sequencing for performing welds and inspections, to accurately change between welding schedules (such as at operation 30), and to perform the welding itself. Errors in any of these responsibilities can result either in rework (if the errors are caught during inspection at operation 60) or a defective part being supplied to the end user. Further, this exemplary semi-automatic welding method hampers productivity, because the operator must spend time configuring and reconfiguring weld schedules.

The above problems demand an improvement in the related art system.

### SUMMARY OF THE INVENTION

In accordance with an embodiment of the present invention, a welding system is provided that includes a welding job sequencer component that is configured to identify a welding sequence for a welding work cell, wherein the welding sequence defines at least a parameter and a welding schedule for a first welding procedure to create a first weld on a workpiece and a second welding procedure to create a second weld on the workpiece. The welding job sequencer component is further configured to utilize the welding sequence in the welding work cell to automatically configure welding equipment to perform the first welding procedure and the second welding procedure on the workpiece without intervention from the operator. In the embodiment, the system can further provide a collection component that is configured to track a weld time for at least one of the first weld or the second weld performed with the welding sequence and a manager component that is configured to ascertain an estimation of consumable depletion based on the weld time for the welding sequence used to perform the first weld or the second weld.

In accordance with an embodiment of the present invention, a method of welding in a welding work cell with a welding sequence is provided that includes at least the steps of: identifying a welding sequence for an operator to use in a welding work cell, wherein the welding sequence defines a first welding procedure that includes a first parameter to create a first weld on a workpiece and a second welding procedure that includes a second parameter to create a second weld on the workpiece; utilizing the welding sequence to automatically modify a welding equipment within the welding work cell without intervention from the operator creating at least one of the first weld or the second weld; collecting a welding parameter during creation of at least one of the first weld or the second weld with the welding sequence; tracking a weld time related to the creation of at least one of the first weld or the second weld with the welding sequence; and increasing an amount of a consumable at the welding work cell based on at least one of the welding parameter or the weld time.

In accordance with an embodiment of the present invention, a welding system is provided that includes at least the following: means for identifying a welding sequence for an operator to use in a welding work cell, wherein the welding sequence defines a first welding procedure that includes a first parameter to create a first weld on a workpiece and a second welding procedure that includes a second parameter to create a second weld on the workpiece; means for utilizing the welding sequence to automatically modify a welding equipment within the welding work cell without intervention from the operator creating at least one of the first weld or the second weld; means for collecting a welding parameter during creation of at least one of the first weld or the second weld with the welding sequence; means for tracking a weld time related to the creation of at least one of the first weld or the second weld with the welding sequence; means for increasing an amount of a consumable at the welding work cell based on at least one of the welding parameter or the weld time; means for calculating a cost based on the weld time for use of the welding sequence; and means for managing an inventory of consumables based on the cost.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a welding operation of the related art utilizing a semi-automatic welding work cell;

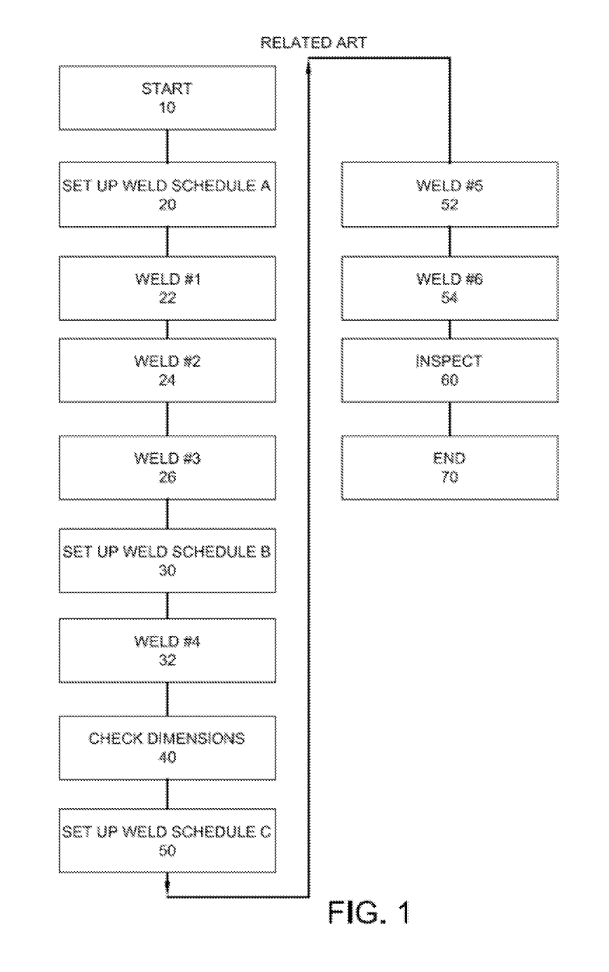

FIG. 2 illustrates a welding operation according to the invention utilizing a semi-automatic welding work cell;

FIG. 3 is a block diagram illustrating a welding system that utilizes a welding job sequencer component to configure welding equipment for two or more weld operations to assembly a workpiece;

FIG. 4 is a block diagram illustrating a welding system that utilizes a welding job sequencer component;

FIG. 5 is a block diagram illustrating a distributed welding environment with a plurality of welding work cells that interface with a welding job sequencer component via a local, remote, or cloud database;

FIG. 6 is a block diagram illustrating a welding system that includes a plurality of welding work cells in which welding work cells are managed by a cloud-based welding job sequencer component;

FIG. 7 is a block diagram illustrating a system that manages an inventory for a welding environment based on a tracking of a use of a welding sequence or a welding parameter with a welding sequence;

FIG. 8 is a block diagram illustrating a system that detects one or more welding parameters to implement a service on a welding equipment that performs one or more welds with a welding sequence;

FIG. 9 is a block diagram illustrating a system that displays media to assist an operator in performing one or more welds with a welding sequence;

FIG. 10 is a block diagram illustrating a system that utilizes a portion of a welding sequence in two or more welding work cells to perform one or more welds;

FIG. 11 is a flow diagram of managing delivery or ordering of materials based on detecting welding parameters and/or a weld time for a welding sequence; and

FIG. 12 is a flow diagram of integrating an identification with a workpiece assembled with a welding sequence.

### DETAILED DESCRIPTION OF THE INVENTION

Embodiments of the invention relate to methods and systems that relate to collecting one or more welding parameters or a weld time during creation of one or more welds using a welding sequence. The one or more welding parameters and/or weld time for each welding sequence is utilized to determine an estimation of consumable depletion for a welding work cell and/or a repair/service to perform on equipment within the welding work cell. Furthermore, the weld time and/or welding parameters can be utilized to manage inventory for a plurality of welding work cells within a welding environment. Other embodiments provided track a cost for a performance of a weld with a welding sequence as well as identifying a workpiece to communicate information related to the one or more welds used for assembly.

According to an aspect of the invention, there is provided a semi-automatic welding work cell including a welding job sequencer that automatically selects a welding schedule for use by an operator in the semi-automatic welding work cell.

According to another aspect of the invention, there is provided a method of welding in a semi-automatic work cell, including automatically selecting a welding schedule for use by an operator in the semi-automatic welding work cell.

According to another aspect of the invention, there is provided a welding production line including at least one semi-automatic welding work cell, where the semi-automatic work cell includes a welding job sequencer that automatically selects a welding schedule for use by an operator therein.

According to another aspect of the invention, there is provided a method of monitoring a welding production line, including automatically selecting a welding schedule for use by an operator in a semi-automatic welding work cell.

The term “component” as used herein can be defined as a portion of hardware, a portion of software, or a combination thereof. A portion of hardware can include at least a processor and a portion of memory, wherein the memory includes an instruction to execute.

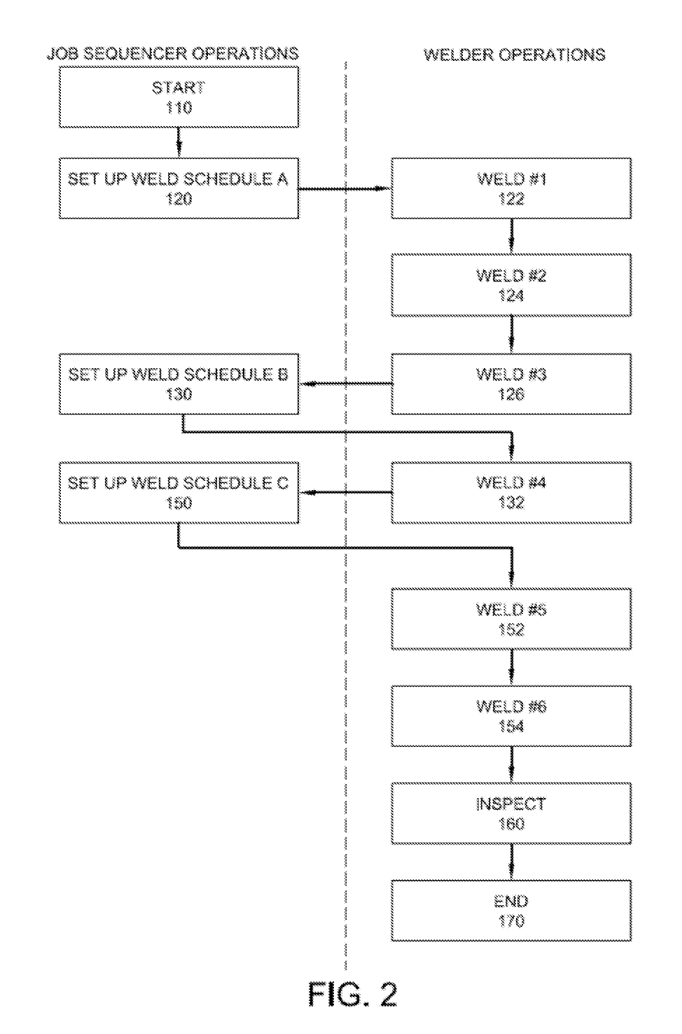

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIG. 2 is referenced. In an exemplary embodiment of the invention as illustrated in FIG. 2, a welding job sequencer is provided. The welding job sequencer improves the semi-automatic work cell of the related art by increasing the productivity of the semi-automatic work cell without compromising the number of weld schedules usable therein. The welding job sequencer accomplishes this improvement by implementing automatic changes in the semi-automatic work cell, and by providing the operator with an array of commands and instructions.

More specifically, in an exemplary embodiment, the welding job sequencer automatically selects and implements a function of the welding work cell. An example of such a function includes a particular weld schedule to be used with the semi-automatic work cell. In other words, the welding job sequencer may select a weld schedule to be used for a particular weld, and modify the settings of the semi-automatic work cell in accordance with the selected weld schedule, automatically for the operator (i.e., without the operator's specific intervention).

Additionally, in the exemplary embodiment, the welding job sequencer may automatically indicate a sequence of operations that the operator should follow to create a final welded assembly. In conjunction with the automatic selection of welding schedules, this indicated sequence allows an operator to follow the sequence to create a final welded part, without having to spend time adjusting, selecting, or reviewing each individual weld schedule and/or sequence.

Accordingly, since the welding job sequencer sets up the welding equipment and organizes the workflow, and since the operator only performs the welding operations themselves, the chance for error in the welding operation is greatly reduced, and productivity and quality are improved.

The exemplary embodiment is diagrammatically represented in FIG. 2. In FIG. 2, at operation 110, the welding job sequencer begins operation, and immediately sets the welding equipment to use weld schedule A (operation 120) and instructs the operator to perform welds #1, #2 and #3. Then, the operator performs welds #1, #2 and #3 using weld schedule A (operations 122, 124 and 126). Next, the welding job sequencer sets the welding equipment to use weld schedule B (operation 130), and instructs the operator to perform weld #4. Then the operator performs weld #4 using weld schedule B (operations 132). After completion of weld schedule B, the welding job sequencer sets the welding equipment to use weld schedule C (operation 150), and instructs the operator to perform welds #5 and #6, and to inspect the part. Then, the operator performs welds #5 and #6 (operations 152, and 154) using weld schedule C, and inspects the completed part to confirm that it is correct (operation 160). This inspection may include dimensional verification, visual defect confirmation, or any other type of check that might be needed. Further, operation 160 may include a requirement that the operator affirmatively indicate that the inspection is complete, such as by pressing an “OK” button, before it is possible to proceed to the next operation. Lastly, the welding job sequencer indicates that the welding operation is at an end (operation 170), and re-sets for the next operation.

Accordingly, as noted above, the sequencing and scheduling of welding operations is completed by the sequencer, and frees the operator to focus on performing welds according to instruction.

The welding job sequencer may select and implement a new function, such as the selection and implementation of weld schedules A, B and C shown in FIG. 2, based upon various variables or inputs. For example, the welding job sequencer may simply select new weld schedules based upon a monitoring of elapsed time since the beginning of the welding operations, or since the cessation of welding (such as the time after weld #3 in FIG. 2 above). Alternatively, the welding job sequencer may monitor the actions of the operator, compare the actions to the identified sequence of welds, and select new weld schedules appropriately. Still further, various combinations of these methods, or any other effective method, may be implemented, as long as the end effect is to provide an automatic selection and implementation of a function, such as the weld schedule, for use by the operator.

Parameters of the selected weld schedule may include such variables as welding process, wire type, wire size, WFS, volts, trim, which wire feeder to use, or which feed head to use, but are not limited thereto.

While the above description focuses on the selection of a weld schedule as a function which is automatically selected and implemented, the welding job sequencer is not limited to using only this function.

For example, another possible function that may be selected and implemented by the welding job sequencer is a selection of one of multiple wire feeders on a single power source in accordance with the weld schedule. This function provides an even greater variability in welding jobs capable of being performed by the operator in the semi-automatic work cell, since different wire feeders can provide a great variance of, for example, wire sizes and types.

Another example of a function compatible with the welding job sequencer is a Quality Check function. This function performs a quality check of the weld (either during welding or after the weld is completed) before allowing the job sequence to continue. The quality check can monitor various welding parameters and can pause the welding operation and alert the operator if an abnormality is detected. An example of a welding parameter measurable by this function would be arc data.

Another example of such a function would be a Repeat function. This function would instruct the operator to repeat a particular weld or weld sequence. An example of the use of this function includes when the Quality Check function shows an abnormality, or when multiple instances of the same weld are required.

Another example of such a function would be a Notify Welder function, which communicates information to the welder. This function would display information, give an audible signal, or communicate with the welder by some other means. Examples of use of this function include an indication to the operator that he is free to begin welding, or an indication that the operator should check some portion of the welded part for quality purposes.

Another example of such a function would be a Enter Job Information function. This function will require the welder to enter information, such as the part serial number, a personal ID number, or other special conditions before the job sequencer can continue. This information could also be read from a part or inventory tag itself through Radio Frequency Identification (RFID), bar code scanning, or the like. The welding job sequencer could then utilize the entered information for the welding operations. An example of the use of this function would be as a predicate to the entire welding operation, so as to indicate to the welding job sequencer which schedules and/or sequences should be selected.

A further example of such a function would be a Job Report function. This function will create a report on the welding job, which could include information such as: the number of welds performed, total and individual arc timing, sequence interruptions, errors, faults, wire usage, arc data, and the like. An example of the use of this function would be to report to a manufacturing quality department on the efficiency and quality of the welding processes.

A still further example of such a function would be a System Check function. This function will establish whether the welding job can continue, and could monitor such parameters as: wire supply, gas supply, time left in the shift (as compared to the required time to finish the job), and the like. The function could then determine whether the parameters indicate that there is enough time and/or material for the welding job to continue. This function would prevent down-time due to material depletion, and would prevent work-in-process assemblies from being delayed, which can lead to quality problems due to thermal and scheduling issues.

Further, as mentioned above, the welding job sequencer may select and implement a new function, based upon various variables or inputs. These variables and inputs are not particularly limited, and can even be another function. For example, another function compatible with the welding job sequencer is a Perform Welding Operation function. This function is designed to detect the actual welding performed by the operator, and to report that welding so that the welding job sequencer can determine whether to proceed with further operations. For example, this function can operate by starting when the operator pulls the trigger to start the welding operation, and finishing when the operator releases the trigger after the welding is complete, or after a predetermined period of time after it starts. This function could end when the trigger is released or it could be configured to automatically turn off after a period of time, a quantity of wire, or an amount of energy is delivered. This function may be used to determine when to select a new function, such as a new weld schedule, as discussed above.

Still further, various semi-automatic and/or robotic work cells can be integrated together on a single network, and the sequencing of welding steps at a single work-cell can be fully integrated into a complete production schedule, which itself can be modified as needed to track variations in the production schedule. Sequencing and/or scheduling information can also be stored in a database, be stored by date as archival information, and be accessed to provide various production reports

In an embodiment, a semi-automatic welding work cell for welding an assembly defined by a plurality of welds can be provided, the plurality of welds being defined by at least two weld schedules can include welding equipment for use by a welding operator to perform said plurality of welds and complete the assembly with said welding equipment having a plurality of functions. In the embodiment, the work cell can include a welding job sequencer that automatically selects a welding schedule for use by an operator in the semi-automatic welding work cell. In the embodiment, the welding job sequencer can select the welding schedule according to an elapsed time. In an embodiment, the welding job sequencer can detect when the operator is conducting a welding operation, and selects the welding schedule based upon that detection. In the embodiment, the welding job sequencer can detect when the operator is conducting a welding operation, and the welding job sequencer selects the welding schedule according to an amount of welding wire supplied for the welding operation. In the embodiment, the welding job sequencer can detect when the operator is conducting a welding operation, and the welding job sequencer selects the welding schedule according to an amount of energy supplied for the welding operation. In the embodiment, the welding schedule includes information about at least one of a welding process, wire type, wire size, WFS, volts, trim, wire feeder to use, or feed head to use.

In an embodiment, the welding work cell can include the welding job sequencer which select and implements at least one of a plurality of functions to define at least a first weld schedule and a second weld schedule from the at least two weld schedules so as to organize a workflow for creating the welded assembly and indicate to the welding operator a sequence of working operations for completing the assembly. In the embodiment, the welding job sequencer can automatically modify the welding equipment in accordance with the workflow and sequence of the welding operations without the welding operator intervening.

In the embodiment, the second weld schedule is defined according to an elapsed time of the first weld schedule. In the embodiment, the at least one function detects completion of said first weld schedule by said operator and automatically changes from said first weld schedule to said second weld schedule. In the embodiment, at least one function detects when the operator is conducting said first weld schedule, and said second weld schedule is defined according to an amount of welding wire supplied for said first weld schedule. In the embodiment, at least one function detects when the operator is conducting said first weld schedule, and said second weld schedule is defined according to an amount of energy supplied for said first weld schedule. In the embodiment, the at least one first weld set up parameter and said at least one second weld set up parameter comprise at least one of a welding process, wire type, wire size, WFS, volts, trim, wire feeder to use, or feed head to use. In the embodiment, at least one first weld set up parameter and said at least one second weld set up parameter comprise a feeder for use by an operator in the semi-automatic welding work cell. In the embodiment, at least one function monitors quality measurables of said weld assembly, wherein the quality measureables comprise at least information about an arc used to form the weld created by the operator In the embodiment, at least one function indicates information to the operator in the semiautomatic welding work cell. In the embodiment, at least one function accepts job information comprising at least a part ID number, operator ID number, or welding instructions. In the embodiment, at least one function produces a job report comprising at least one of a number of welds preformed, total arc time, individual arc time, sequence interruptions, errors, faults, wire usage, arc data. In the embodiment, at least one function includes a system check of said cell, the system check comprising at least a detection of wire supply, gas supply, and time.

In the embodiment, the welding job sequencer can select a welding sequence for use by the operator in the semi-automatic welding work cell. In the embodiment, the welding job sequencer can indicate the selected welding sequence to the operator in the semi-automatic welding work cell. In the embodiment, the welding job sequencer can select a wire feeder for use by an operator in the semi-automatic welding work cell. In the embodiment, the welding job sequencer can monitor quality measurables of a weld created by the operator, wherein the quality measureables comprise at least information about an arc used to form the weld created by the operator. In the embodiment, the welding job sequencer can indicate information to the operator in the semi-automatic welding work cell. In the embodiment, the welding job sequencer can accept job information comprising at least a part ID number, operator ID number, or welding instructions. In the embodiment, the welding job sequencer can produce a job report comprising at least one of a number of welds preformed, total arc time, individual arc time, sequence interruptions, errors, faults, wire usage, arc data. In the embodiment, the welding job sequencer can perform a system check comprising at least a detection of wire supply, gas supply, and time.

In an embodiment, a method of welding in a semi-automatic work cell can be provided that includes automatically selecting a welding schedule for use by an operator in the semi-automatic welding work cell. In the embodiment, the automatic selection can be performed after an elapsed time. In the embodiment, the method can include detecting when the operator is conducting a welding operation, wherein the automatic selection is performed based upon that detection. In the embodiment, the method can include detecting when the operator is conducting a welding operation, wherein the automatic selection is performed according to an amount of welding wire supplied for the welding operation. In the embodiment, the method can include detecting when the operator is conducting a welding operation, wherein the automatic selection is performed according to an amount of energy supplied for the welding operation. In the embodiment, the welding schedule can include information about at least one of a welding process, wire type, wire size, WFS, volts, trim, wire feeder to use, or feed head to use.

In the embodiment, the method can include selecting a welding sequence for use by the operator in the semi-automatic welding work cell. In the embodiment, the method can include indicating the selected welding sequence to the operator in the semi-automatic welding work cell. In the embodiment, the method can include selecting a wire feeder for use by an operator in the semi-automatic welding work cell. In the embodiment, the method can include monitoring quality measurables of a weld created by the operator, wherein the quality measureables comprise at least information about an arc used to form the weld created by the operator. In the embodiment, the method can include indicating information to the operator in the semi-automatic welding work cell. In the embodiment, the method can include accepting job information comprising at least a part ID number, operator ID number, or welding instructions. In the embodiment, the method can include producing a job report comprising at least one of a number of welds performed, total arc time, individual arc time, sequence interruptions, errors, faults, wire usage, arc data. In the embodiment, the method can include performing a system check comprising at least a detection of wire supply, gas supply, and time.

In an embodiment, a welding production line is provided with at least one semi-automatic welding work cell, wherein the semi-automatic work cell that includes a welding job sequencer that automatically selects a welding schedule for use by an operator therein. In the embodiment, the welding production line includes a monitoring system that communicates with the welding job sequencer to direct the welding job sequencer to automatically select the welding schedule for use by the operator therein.

In an embodiment, a method of monitoring a welding production line is provided that includes automatically selecting a welding schedule for use by an operator in a semi-automatic welding work cell. In the embodiment, the method can include directing the welding job sequencer to automatically select the welding schedule for use by the operator therein.

In an embodiment, a semi-automatic welding work cell is provided that includes a welding job sequencer that automatically selects a welding schedule for use by an operator in the semi-automatic welding work cell. The automatic selection may be by way of elapsed time, a detection of welding operations, a detection of the amount of welding wire supplied for the welding operation, or a detection of the amount of energy supplied for the welding operation.

In an embodiment, a method of welding in a semi-automatic work cell having welding equipment and a welding job sequencer to complete an assembly defined by a plurality of welds can be provided in which the plurality of welds can be defined by at least two weld schedules. The embodiment can include at least the steps of the following: implementing a welding equipment function with the welding job sequencer to define from the at least two weld schedules a first weld schedule having at least one first weld set up parameter and at least one first weld instruction and a second weld schedule having at least one second weld set up parameter and at least one second weld instruction, at least one of the said second weld set up parameter and said second weld instruction is different from said first weld set up parameter and said first weld instruction; indicating to a welding operator a sequence of welding operations for completing the assembly based on said first and second weld schedules; and automatically modifying said welding equipment in accordance with said sequence of welding operations for completing the assembly based on said first and second weld schedules.

In the embodiment, the method can include defining said second weld schedule is performed after an elapsed time defined by said first weld schedule. In the embodiment, the method can include detecting when the operator is conducting said first weld schedule, wherein defining said second schedule is based upon that detection. In the embodiment, defining said first and second weld schedules can include defining an amount of welding wire supplied for the welding operation. In the embodiment, defining said second weld schedule is according to an amount of energy supplied for the welding operation for said first weld schedule. In the embodiment, defining at least one of the first and second weld schedules can include selecting at least one of a welding process, wire type, wire size, WFS, volts, trim, wire feeder to use, or feed bead to use. In an embodiment, defining at least one of the first and second weld schedules can include selecting a wire feeder for use by an operator in the semi-automatic welding work cell. In an embodiment, the method can include monitoring quality measurables of a weld created by the operator, wherein the quality measureables comprise at least information about an arc used to form the weld created by the operator. In an embodiment, the method can include indicating information to the operator in the semi-automatic welding work cell. In an embodiment, the method can include accepting job information comprising at least a part ID number, operator ID number, or welding instructions. In an embodiment, the method can include producing a job report comprising at least one of a number of welds performed, total arc time, individual arc time, sequence interruptions, errors, faults, wire usage, arc data performing a system check comprising at least a detection of wire supply, gas supply, and time.

In an embodiment, a welding production line is provided that includes at least one semi-automatic welding work cell for welding an assembly defined by a plurality of welds, the plurality of welds being defined by at least weld schedules, the semi-automatic welding work cell including welding equipment for use by a welding operator to perform the plurality of welds and complete the assembly, the welding equipment having a plurality of functions. In the embodiment, the production line can include a welding job sequencer which selects and implements at least one of the plurality of functions to define at least a first and a second weld schedule in a sequence of welding operations from the at least two weld schedules to be used by said welding operator for completing the weld assembly. In an embodiment, the production line can include said first weld schedule contains at least one first weld set up parameter and at least one first weld instruction for said welding operator and said second weld schedule contains at least one second weld set up parameter and at least one second weld instruction for said welding operator, at least one of said first weld set up parameter and said first weld instruction is different from said second weld set up parameter and said second weld instruction, said welding job sequencer automatically modifying said welding equipment in accordance with said sequence of operations without said welding operator intervention. In an embodiment, the production line can include a monitoring system in communication with the welding job sequencer to monitor completion of the at least one weld instruction of each of the first and second weld schedule.

In an embodiment, a method for monitoring a welding production line in at least one semi-automatic welding work cell for use by a welding operator to complete an assembly defined by a plurality of welds, the plurality of welds being defined by at least two weld schedules, the semi-automatic welding work cell including welding equipment and a welding job sequencer. The method can include at least the following steps: defining at least a first and a second weld schedule in a sequence of welding operations from the at least two weld schedules with the welding job sequencer said first weld schedule having at least one first weld set up parameter and at least one first weld instruction and said second weld schedule defining at least one second weld set up parameter and at least one second weld instruction with at least one of said second weld set up parameter and said second weld instruction being different from said first weld set up parameter and said first weld instruction; determining completion of said first weld schedule by said welding operator; automatically modifying the welding equipment in accordance with said second weld schedule without said welding operator intervention; and monitoring the welding operations. In the embodiment, the method can include automatically modifying the welding equipment in accordance with said second weld schedule is based on said completion of said first weld schedule.

In an embodiment, a semi-automatic welding work cell for use by an operator is provided. The embodiment can include welding equipment having a plurality of functions for performing welds by the operator and a welding job sequencer selecting from the plurality of functions to set up and organize the welding equipment for the operator. The embodiment can include the plurality of functions including: a weld schedule function defined by a sequence of weld operations; a notify function to instruct the operator to perform the weld schedule; and a quality check function to monitor at least one weld operation of the sequence of weld operations.

In the embodiment, the quality check function performs a quality check on a weld completed by the at least one weld operation. In the embodiment, the quality check function monitors the at least one weld operation during the at least one weld operation. In the embodiment, the quality check function monitors the at least one weld operation after completion of the at least one weld operation. In the embodiment, the weld schedule function defines a plurality of weld schedules, each weld schedule having a first weld operation and at least a second weld operation. In the embodiment, the quality check function monitors the at least one weld operation before allowing the sequence of weld operations to continue. In the embodiment, the quality check function detects an abnormality, the sequencer pauses the sequence of weld operations and the notify function alerts the operator of the abnormality.

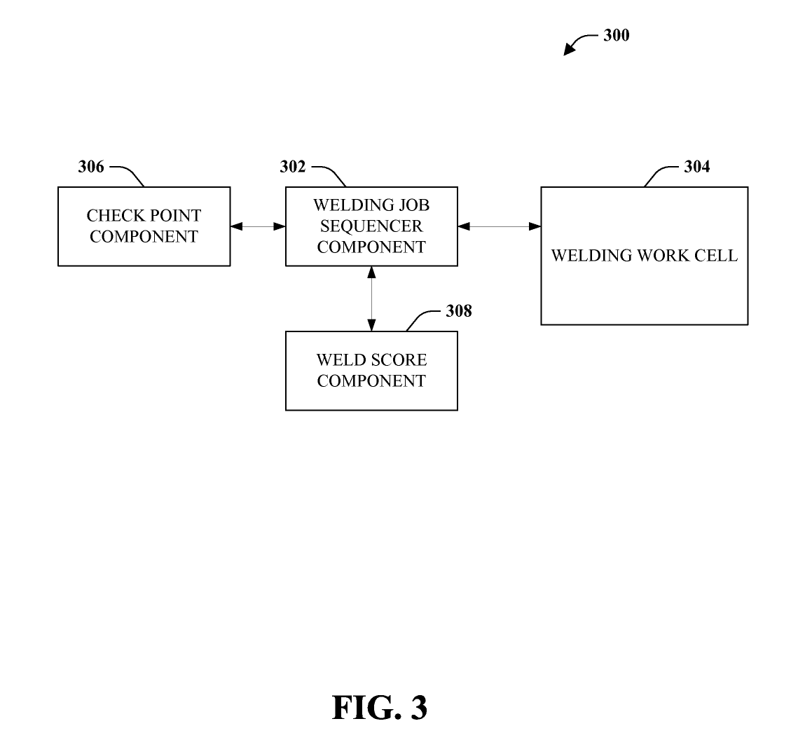

FIG. 3 is a schematic block diagram of an exemplary embodiment of welding system 300 that utilizes welding job sequencer component 302 to configure welding equipment for two or more weld operations to assembly a workpiece. Welding job sequencer component 302 that is configured to implement a welding sequence that includes settings, configurations, and/or parameters to perform two or more welding procedures on a workpiece. In particular, welding job sequencer component 302, as discussed above as welding job sequencer, automatically configures welding equipment to create two or more welds that include two or more welding schedules. Moreover, welding job sequencer component 302 utilizes the welding sequence to aid an operator to perform the two or more welds. As discussed above, welding job sequencer component 302 can be utilized with welding work cell 304 that is semi-automatic. However, it is to be appreciated and understood that welding job sequencer component 302 can be implemented in a suitable welding environment or system that includes at least welding equipment and an operator to facilitate creating one or more welds.

Welding system 300 further includes check point component 306 that is configured to monitor a welding process and/or a welding operator. It is to be appreciated that check point component 306 can be substantially similar to CHECKPOINT™, or any quality assessment component that evaluates whether a weld created meets a defined standard. In an example, check point component 306 can monitor in real time or be a reporting component that collects data after a weld has been performed. For instance, the welding process is monitored in real time or after a weld is completed to detect at least one of a welding parameter (e.g., voltage, current, among others), a welding schedule parameter (e.g., welding process, wire type, wire size, WFS, volts, trim, wire feeder to use, feed head to use, among others), a weld on a workpiece as the weld is created, a movement of an operator, a position of a welding tool, a position or location of a welding equipment, a position or location of an operator, sensor data (e.g., video camera, image capture, thermal imaging device, heat sensing camera, temperature sensor, among others), and the like. Check point component 306 includes an alert system (not shown) that can communicate an alert or notification to indicate a status of the real time monitoring. In an embodiment, check point component 306 can utilize thresholds, ranges, limits, and the like for the monitoring to precisely identify a abnormality with welding system 300. Furthermore, check point component 306 can communicate an alert or notification to welding work cell 304 or the operator to at least one of stop the welding procedure, continue with the welding procedure, pause the welding procedure, terminate the welding procedure, or request approval of the welding procedure. In an embodiment, check point component 306 can store monitoring data (e.g., video, images, results, sensor data, and the like) in at least one of a server, a data store, a cloud, a combination thereof, among others.

Weld score component 308 is included with welding system 300 and is configured to evaluate a weld created by an operator within welding work cell 304 upon completion of such weld. It is to be appreciated that check point component 306 can be substantially similar to WELDSCORE® or any quality assessment component that evaluates whether an operator is able to perform a weld with defined standards. Weld score component 308 provides a rating or score for the completed weld to facilitate implementing a quality control on the workpiece and/or assembly of the workpiece. For instance, weld score component 308 can alert a quality inspection upon completion, provide data collection of a job (e.g., assembly of workpiece, weld on workpiece, among others), and the like. In an embodiment, an in-person quality inspection can be performed upon completion of a portion of the assembly (e.g., completion of a weld, completion of two or more welds, completion of assembly, among others). In another embodiment, weld score component 308 can utilize a sensor to collect data (e.g., video camera, image capture, thermal imaging device, heat sensing camera, temperature sensor, among others) to determine approval of the job. For instance, a quality inspection can be performed remotely via video or image data collected upon completion of a job to evaluate a characteristic of a weld.

It is to be appreciated that welding job sequencer component 302 can be a stand-alone component (as depicted), incorporated into welding work cell 304, incorporated into check point component 306, incorporated into weld score component 308, or a suitable combination thereof. Additionally, as discussed below, welding job sequencer component 302 can be a distributed system, software-as-a-service (SaaS), a cloud-based system, or a combination thereof. Further, it is to be appreciated and understood that check point component 306 can be a stand-alone component (as depicted), incorporated into welding work cell 304, incorporated into welding job sequencer component 302, incorporated into weld score component 308, or a suitable combination thereof. Additionally, check point component 306 can be a distributed system, software-as-a-service (SaaS), a cloud-based system, or a combination thereof. Moreover, it is to be appreciated and understood that weld score component 308 can be a stand-alone component (as depicted), incorporated into welding work cell 304, incorporated into welding job sequencer component 302, incorporated into check point component 306, or a suitable combination thereof. Additionally, weld score component 308 can be a distributed system, software-as-a-service (SaaS), a cloud-based system, or a combination thereof.

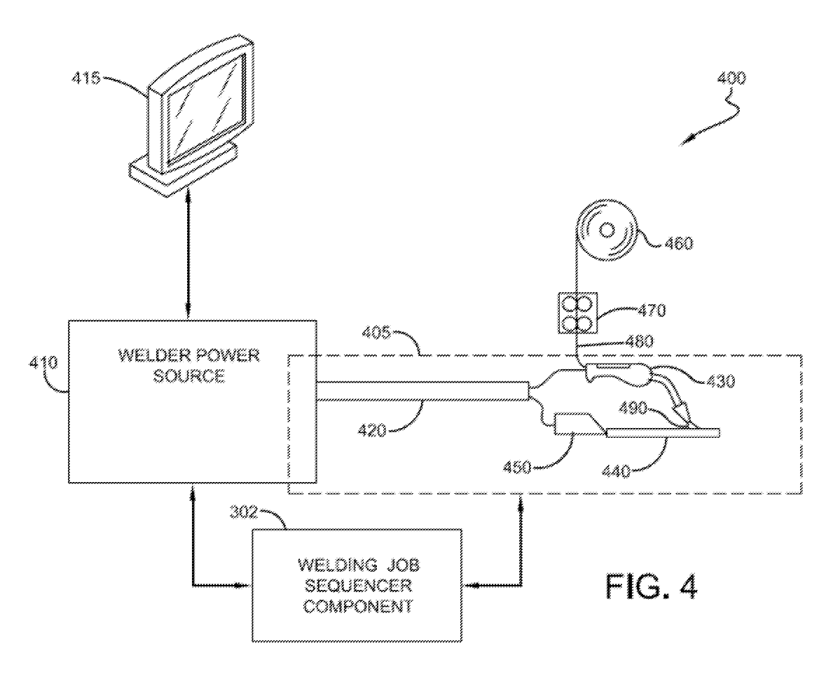

FIG. 4 illustrates a schematic block diagram of an exemplary embodiment of welding system 400 including welding circuit path 405. It is to be appreciated that welding system 400 is also referred to as the welding work cell, wherein the welding work cell and/or welding system 400 can produce welds or welded parts. Welding system 400 includes welder power source 410 and display 415 operationally connected to welder power source 410. Alternatively, display 415 may be an integral part of welder power source 410. For instance, display 415 can be incorporated into welder power source 410, a stand-alone component (as depicted), or a combination thereof. Welding system 400 further includes welding cable 420, welding tool 430, workpiece connector 450, spool of wire 460, wire feeder 470, wire 480, and workpiece 440. Wire 480 is fed into welding tool 430 from spool 460 via wire feeder 470, in accordance with an embodiment of the present invention. In accordance with another embodiment of the present invention, welding system 400 does not include spool of wire 460, wire feeder 470, or wire 480 but, instead, includes a welding tool comprising a consumable electrode such as used in, for example, stick welding. In accordance with various embodiments of the present invention, welding tool 430 may include at least one of a welding torch, a welding gun, and a welding consumable.

Welding circuit path 405 runs from welder power source 410 through welding cable 420 to welding tool 430, through workpiece 440 and/or to workpiece connector 450, and back through welding cable 420 to welder power source 410. During operation, electrical current runs through welding circuit path 405 as a voltage is applied to welding circuit path 405. In accordance with an exemplary embodiment, welding cable 420 comprises a coaxial cable assembly. In accordance with another embodiment, welding cable 420 comprises a first cable length running from welder power source 410 to welding tool 430, and a second cable length running from workpiece connector 450 to welder power source 410.

Welding system 400 includes welding job sequencer component 302 (as described above). Welding job sequencer component 302 is configured to interact with a portion of welding system 400. For instance, welding job sequencer component 302 can interact with at least the power source 410, a portion of welding circuit path 405, spool of wire 460, wire feeder 470, or a combination thereof. Welding job sequencer component 302 automatically adjusts one or more elements of welding system 400 based on a welding sequence, wherein the welding sequence is utilized to configure welding system 400 (or an element thereof) without operator intervention in order to perform two or more welding procedures with respective settings or configurations for each welding procedure.

In an embodiment, welding job sequencer component 302 employs a welding sequence to automatically configure welding equipment. It is to be appreciated that welding system 400 or welding work cell can employ a plurality of welding sequences for assembly of one or more workpieces. For instance, a workpiece can include three (3) welds to complete assembly in which a first welding sequence can be used for the first weld, a second welding sequence can be used for the second weld, and a third welding sequence can be used for the third weld. Moreover, in such example, the entire assembly of the workpiece including the three (3) welds can be referenced as a welding sequence. In an embodiment, a welding sequence that includes specific configurations or steps can further be included within a disparate welding sequence (e.g., nested welding sequence). A nested welding sequence can be a welding sequence that includes a welding sequence as part of the procedure. Moreover, the welding sequence can include at least one of a parameter, a welding schedule, a portion of a welding schedule, a step-by-step instruction, a portion of media (e.g., images, video, text, and the like), a tutorial, among others. In general, the welding sequence can be created and employed in order to guide an operator through welding procedure(s) for specific workpieces without the operator manually setting welding equipment to perform such welding procedures. The subject innovation relates to creating a welding sequence and/or modifying a welding sequence.

One or more welder power source(s) (e.g., welder power source 410) aggregates data respective to a respective welding process to which the welder power source is providing power to implement. Such collected data relates to each welder power source and is herein referred to as “weld data.” Weld data can include welding parameters and/or information specific to the particular welding process the welder power source is supplying power. For instance, weld data can be an output (e.g., a waveform, a signature, a voltage, a current, among others), a weld time, a power consumption, a welding parameter for a welding process, a welder power source output for the welding process, and the like. In an embodiment, weld data can be utilized with welding job sequencer component 302. For example, weld data can be set by a welding sequence. In another example, weld data can be used as a feedback or a feedforward loop to verify settings.

In one embodiment, welding job sequencer component 302 is a computer operable to execute the disclosed methodologies and processes, including methods 1100 and 1200 described herein. In order to provide additional context for various aspects of the present invention, the following discussion is intended to provide a brief, general description of a suitable computing environment in which the various aspects of the present invention may be implemented. While the invention has been described above in the general context of computer-executable instructions that may run on one or more computers, those skilled in the art will recognize that the invention also may be implemented in combination with other program modules and/or as a combination of hardware and/or software. Generally, program modules include routines, programs, components, data structures, etc., that perform particular tasks or implement particular abstract data types.

Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like, each of which may be operatively coupled to one or more associated devices. The illustrated aspects of the invention may also be practiced in distributed computing environments where certain tasks are performed by remote processing devices that are linked through a communications network. In a distributed computing environment, program modules may be located in both local and remote memory storage devices. For instance, a remote database, a local database, a cloud-computing platform, a cloud database, or a combination thereof can be utilized with welding job sequencer 302.

Welding job sequencer 302 can utilize an exemplary environment for implementing various aspects of the invention including a computer, wherein the computer includes a processing unit, a system memory and a system bus. The system bus couples system components including, but not limited to the system memory to the processing unit. The processing unit may be any of various commercially available processors. Dual microprocessors and other multi-processor architectures also can be employed as the processing unit.

The system bus can be any of several types of bus structure including a memory bus or memory controller, a peripheral bus and a local bus using any of a variety of commercially available bus architectures. The system memory can include read only memory (ROM) and random access memory (RAM). A basic input/output system (BIOS), containing the basic routines that help to transfer information between elements within welding job sequencer 302, such as during start-up, is stored in the ROM.

Welding job sequencer 302 can further include a hard disk drive, a magnetic disk drive, e.g., to read from or write to a removable disk, and an optical disk drive, e.g., for reading a CD-ROM disk or to read from or write to other optical media. Welding job sequencer 302 can include at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other magnetic storage devices, or any other medium which can be used to store the desired information and which can be accessed by welding job sequencer 302.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, Radio Frequency (RF), Near Field Communications (NFC), Radio Frequency Identification (RFID), infrared, and/or other wireless media. Combinations of any of the above should also be included within the scope of computer readable media.

A number of program modules may be stored in the drives and RAM, including an operating system, one or more application programs, other program modules, and program data. The operating system in welding job sequencer 302 can be any of a number of commercially available operating systems.

In addition, a user may enter commands and information into the computer through a keyboard and a pointing device, such as a mouse. Other input devices may include a microphone, an IR remote control, a track ball, a pen input device, a joystick, a game pad, a digitizing tablet, a satellite dish, a scanner, or the like. These and other input devices are often connected to the processing unit through a serial port interface that is coupled to the system bus, but may be connected by other interfaces, such as a parallel port, a game port, a universal serial bus (“USB”), an IR interface, and/or various wireless technologies. A monitor (e.g., display 415), or other type of display device, may also be connected to the system bus via an interface, such as a video adapter. Visual output may also be accomplished through a remote display network protocol such as Remote Desktop Protocol, VNC, X-Window System, etc. In addition to visual output, a computer typically includes other peripheral output devices, such as speakers, printers, etc.

A display (in addition or in combination with display 415) can be employed with welding job sequencer 302 to present data that is electronically received from the processing unit. For example, the display can be an LCD, plasma, CRT, etc. monitor that presents data electronically. Alternatively or in addition, the display can present received data in a hard copy format such as a printer, facsimile, plotter etc. The display can present data in any color and can receive data from welding job sequencer 302 via any wireless or hard wire protocol and/or standard. In another example, welding job sequencer 302 and/or system 400 can be utilized with a mobile device such as a cellular phone, a smart phone, a tablet, a portable gaming device, a portable Internet browsing device, a Wi-Fi device, a Portable Digital Assistant (PDA), among others.

The computer can operate in a networked environment using logical and/or physical connections to one or more remote computers, such as a remote computer(s). The remote computer(s) can be a workstation, a server computer, a router, a personal computer, microprocessor based entertainment appliance, a peer device or other common network node, and typically includes many or all of the elements described relative to the computer. The logical connections depicted include a local area network (LAN) and a wide area network (WAN). Such networking environments are commonplace in offices, enterprise-wide computer networks, intranets and the Internet.

When used in a LAN networking environment, the computer is connected to the local network through a network interface or adapter. When used in a WAN networking environment, the computer typically includes a modem, or is connected to a communications server on the LAN, or has other means for establishing communications over the WAN, such as the Internet. In a networked environment, program modules depicted relative to the computer, or portions thereof, may be stored in the remote memory storage device. It will be appreciated that network connections described herein are exemplary and other means of establishing a communications link between the computers may be used.

Alternatively or in addition, a local or cloud (e.g., local, cloud, remote, among others) computing platform can be utilized for data aggregation, processing, and delivery. For this purpose, the cloud computing platform can include a plurality of processors, memory, and servers in a particular remote location. Under a software-as-a-service (SaaS) paradigm, a single application is employed by a plurality of users to access data resident in the cloud. In this manner, processing requirements at a local level are mitigated as data processing is generally done in the cloud, thereby relieving user network resources. The software-as-a-service application allows users to log into a web-based service (e.g., via a web browser) which hosts all the programs resident in the cloud.

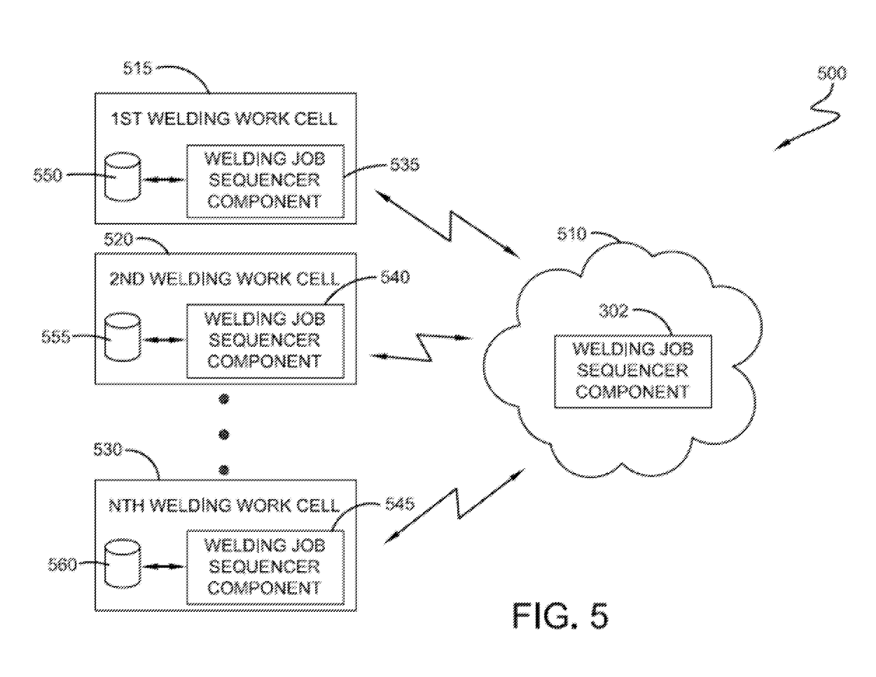

Turning to FIG. 5, system 500 illustrates a welding environment with a plurality of welding work cells via a local, remote, or cloud database. System 500 includes a plurality of welding work cells such as first welding work cell 515, second welding work cell 520 to Nth welding work cell 530, where N is a positive integer. In an embodiment, each welding work cell includes a welding job sequencer component 535, 540, and 545, that is used to implement a welding schedule(s) to each welding work cell as well as or in the alternative to an enterprise-wide welding operation(s) and/or enterprise-wide welding work cell. Welding sequence(s) from each welding job sequencer component 535, 540, and 545 is received from the local or cloud database (e.g., local database, cloud database, remote database, among others) computing platform 510.

In an embodiment, each welding work cell further includes a local data store. For instance, first welding work cell 515 includes welding job sequencer component 535 and data store 550, second welding work cell 520 includes welding job sequencer component 540 and data store 555, and Nth welding work cell 530 includes welding job sequencer component 545 and data store 560. It is to be appreciated that system 500 includes welding job sequencer 302 hosted by computing platform 510 in which each welding work cell includes a distributed and respective welding job sequencer component. Yet, it is to be understood that welding job sequencer 302 (and distributed welding job sequencer components 535, 540, and 545) can be a stand-alone component in each welding work cell or a stand-alone component in the computing platform 510.

Each welding work cell can include a respective data store that stores a portion of at least one welding sequence. For instance, welding sequences related to a welding process A is employed at one or more welding work cell. The welding sequence is stored in a respective local data store (e.g., data stores 550, 555, and 560). Yet, it is to be appreciated and understood that each welding work cell can include a local data store (as depicted), a collective and shared remote data store, a collective and shared local data store, a cloud data store hosted by computing platform 510, or a combination thereof. A “data store” or “memory” can be, for example, either volatile memory or nonvolatile memory, or can include both volatile and nonvolatile memory. The data store of the subject systems and methods is intended to comprise, without being limited to, these and other suitable types of memory. In addition, the data store can be a server, a database, a hard drive, a flash drive, an external hard drive, a portable hard drive, a cloud-based storage, a solid-state drive, and the like.

For instance, welding job sequencer component 302 can manage each welding job sequencer component 535, 540, 545 in each welding work cell 515, 520, 530. In another embodiment, the communications can be transmitted from the welding job sequencer 302 to each welding work cell (e.g., each welding job sequencer component). In another embodiment, the communications can be received from each welding work cell (e.g., each welding job sequencer component) from the welding job sequencer component 302. For instance, a welding sequence can be used with 1^{st} welding work cell 515 and communicated directly to a disparate welding work cell or via computing platform 510.

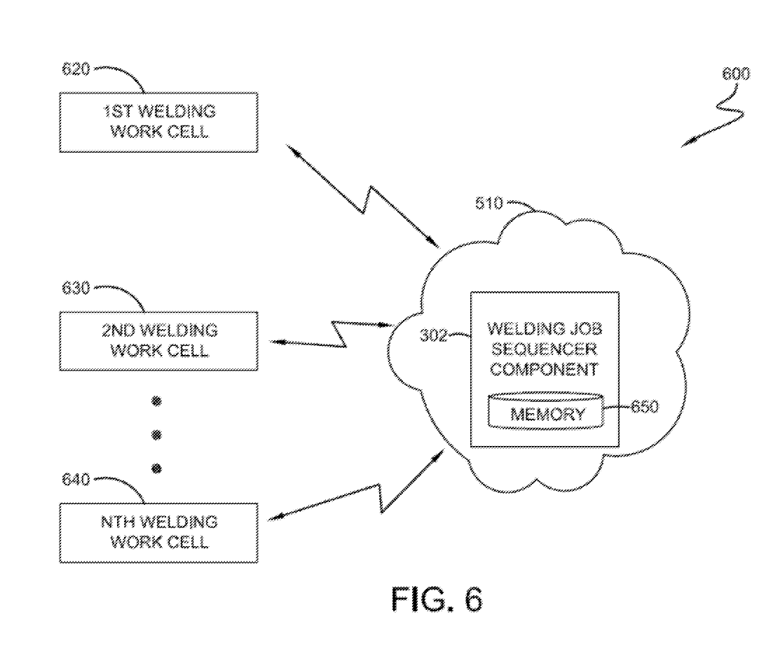

FIG. 6 illustrates welding system 600 that includes a plurality of welding work cells in which welding job sequencer component 302 is hosted with computing platform 510 to utilize one or more welding sequences to configure welding equipment within one or more welding systems, welding environments, and/or welding work cells. Welding system 600 includes a local or cloud-based welding job sequencer component 302 hosted in computing platform 510. Welding job sequencer component 302 can utilize a welding sequence with a number of welding work cells. For instance, welding system 600 can have a number of welding work cells such as, but not limited to, 1^{st} welding work cell 620, 2^{nd} welding work cell 630, to Nth welding work cell, where N is a positive integer. It is to be appreciated that the locality of the welding job sequencer component 302 is in relation to each 1^{st} welding work cell 620, 2^{nd} welding work cell 630, and/or Nth welding work cell 640.

In an embodiment, welding job sequencer 302 communicates one or more welding sequences to a target welding work cell, wherein the target welding work cell is a welding work cell that is to utilize the communicated welding sequence. Yet, in another embodiment, welding job sequencer 302 utilizes memory 650 hosted by computing platform 510 in which one or more welding sequences are stored. Yet, the stored welding sequence can be related or targeted to one or more welding work cells regardless of a storage location (e.g., local, cloud, remote, among others).

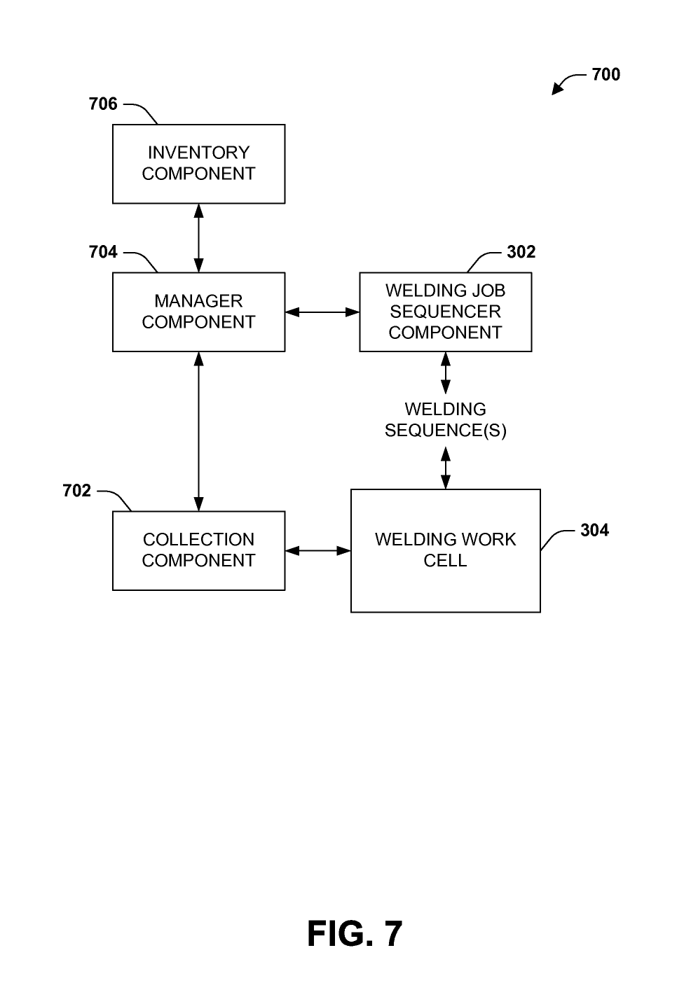

FIG. 7 illustrates system 700 that manages an inventory for a welding environment based on a tracking of a use of a welding sequence or a welding parameter with a welding sequence. System 700 further includes collection component 702 that is configured to collect data from a welding operation that uses a welding sequence. In general, collection component 702 collects, receives, and/or aggregates a welding parameter from a weld being performed with use of a portion of a welding sequence. For instance, a welding parameter is aggregated, received, or collected for a welding sequence that is used to perform one or more welds. Additionally, collection component 702 collects, receives, and/or aggregates a weld time for the welding sequence in which the weld time corresponds to an amount of time the operator is performing the one or more welds with the welding sequence. It is to be appreciated that weld time can be a welding parameter that collection component 702 gathers from a welding work cell.

By way of example and not limitation, the welding parameter can be at least one of a parameter for the weld (e.g., voltage, current, among others), a weld time (e.g., an amount of time that an operator is performing one or more welds for a welding sequence), an arc time, an amount of wire consumed, a duration of time a wire feeder is feeding wire, a welding schedule parameter (e.g., welding process, wire type, wire size, wire feed speed (WFS), volts, trim, wire feeder to use, feed head to use, among others), physical weld appearance (e.g., weld size, weld shape, weld dimension(s), and the like), welding equipment configurations (e.g., power source settings, waveforms, wire feed speed, and the like), welder setup (e.g., workpiece type, wire type, material type, weld to perform, and the like), a time to create a weld, a cost to create the weld (e.g., cost includes electricity, electrode, gas, employee pay, among others), among others. Still, it is to be appreciated and understood that any welding parameter can be selected with sound engineering judgment without departing from the intended scope of coverage of the embodiments of the subject invention.

System 700 further includes manager component 704 that is configured to control at least inventory 706 based on the collected welding parameter(s) via collection component 702. In particular, manager component 704 manages an amount of a consumable or other materials used with a welding environment and/or welding work cell 304. For instance, materials or consumables can be, but are not limited to, welding equipment parts, gas, tips, wire, among others. By way of example and not limitation, a welding parameter for a welding sequence can be received via collection component 702 and evaluated by manager component 704 to determine a rate of use for a consumable. The rate of use can be, for instance, based on a weld time tracked, the welding parameter collected, among others. Thus, manager component 704 creates an estimation of consumable depletion based on collected data (e.g., welding parameter, weld time, among others). It is to be appreciated that an estimation of consumable depletion can be defined as a rate or amount of use for a particular consumable based on a welding parameter collected or a weld time for a welding sequence used. Moreover, the estimation of consumable depletion can be for an entire welding environment (e.g., a plurality of welding work cells 304) and/or each individual welding work cell 304. For instance, system 700 can determine a number of a consumable that is used for a welding sequence used for a duration of time (e.g., number of welding tips used for welding sequence Win five (5) hours).

Manager component 704 can extrapolate the rate or estimation of consumable depletion based on the data received from collection component 702. In an embodiment, manager component can compare an amount of a consumable with inventory 706 to determine whether or not an estimation of consumable depletion will deplete or exhaust inventory 706. Inventory 706 is defined as a storage or an amount of a consumable for at least one of a welding environment (e.g., one or more welding work cells 304) or a welding work cell 304. In an example, inventory 706 for a welding environment can be compared with estimated consumable depletion for each welding work cell to determine whether additional consumable(s) are to be provided. Thus, manager component 704 is configured to order or communicate a request for additional materials (e.g., consumables) from a supplier for the welding environment. In another example, manager component 704 is configured to request or communicate a delivery of consumables to welding work cell 304 based on a comparison of the estimate of consumable depletion with an amount of consumable at welding work cell 304.

Still, it is to be appreciated and understood that a data collection by collection component 702 can be in real time, seamless, delayed, or a combination thereof. For instance, a real time data collection can collect data while the data is being generated taking into consideration of standard delays in communications, data systems, computers, and the like. By way of example and not limitation, a welding parameter can be collected in real time such that the welding parameter is monitored at substantially the same time that the welding sequence is being used with a welding operation in order to capture readings related to the welding parameter. Thus, although the welding parameter is not instantaneously captured, the capture is to be considered real time with negligible delay from the signals, systems, computers, and the like.

It is to be appreciated that collection of a welding parameter for a welding sequence can be utilized in one or more environments independent of a source or collection of the welding parameter (e.g., independent of where a welding sequence is used and where the data collection takes place). For instance, an operator can perform two or more welds with welding sequence W in welding environment A and further utilize welding parameters collected from the two or more welds with welding sequence W to determine inventory management in welding environment B. In another example, real time data for welding parameters can be collected (while using welding sequence W) across welding environment A and welding environment B to determine inventory management for the welding sequence W for use in welding environment A, welding environment B, and/or welding environment C.

In an example, a welding sequence can include a replenishment of a consumable. The welding sequence can be created or edited to include a replenishment of a consumable for at least one of a welding work cell, a welding equipment, among others. For instance, a replenishment of a consumable can be included with a welding sequence after a period of time, wherein the period of time is estimated based on the duration the welding equipment is used (e.g., estimate the use of consumables). Thus, a welding environment, welding system, and/or welding work cell can be evaluated in real time or from collected real time data and identify data to determine a replenishment of a consumable.

In another example, a welding sequence can include an inspection or a repair. The welding sequence can be created or edited to include an inspection request or a repair request based on a factor such as, but not limited to, a time, a duration, among others. A welding work cell can have a maintenance period for a particular time and if a welding sequence is created for such welding work cell, a repair or maintenance can be included with the created welding sequence. Thus, a welding environment, welding system, and/or welding work cell can be evaluated in real time or from collected real time data and identify data to determine inspections or repairs.

In another example, a welding sequence can include a pre-shift routine that is performed prior to a welding operation. For instance, a shift can be part of a scheduling of operators or employees, wherein the shift is a duration of time when operators are working. As an example, a shift can be from seven (7) am to three (3) pm. Based on gathered historic welding data or real time welding data, an estimation of welding time can be calculated to facilitate determining maintenance to perform on welding equipment. In an embodiment, at least one of gas flow, tip condition, tip replacement, nozzle inspection, nozzle replacement, among others can be included within a welding sequence based on the estimation of welding time.

Furthermore, it is to be appreciated and understood that collection component 702 can be a stand-alone component (as depicted), incorporated into welding job sequencer component 302, incorporated into welding equipment (not shown), incorporated into manager component 704, incorporated into inventory 706, incorporated into welding work cell 304, or a combination thereof. Additionally, welding job sequencer component 302 can be a stand-alone component (as depicted), incorporated into collection component 702, incorporated into welding equipment (not shown), incorporated into manager component 704, incorporated into inventory 706, incorporated into welding work cell 304, or a combination thereof. Further, system 700 can utilize a data store (not shown but discussed above) to store data (e.g., collected welding parameter(s), welding sequences, inventory information, orders generated, estimations, welding work cell estimates, repair history, and the like) related to system 700, wherein the data store can be a local data store, a remote data store, a cloud-based data store, a computing platform, and/or any other network or computing environment configuration discussed above in regards to the welding job sequencer component.

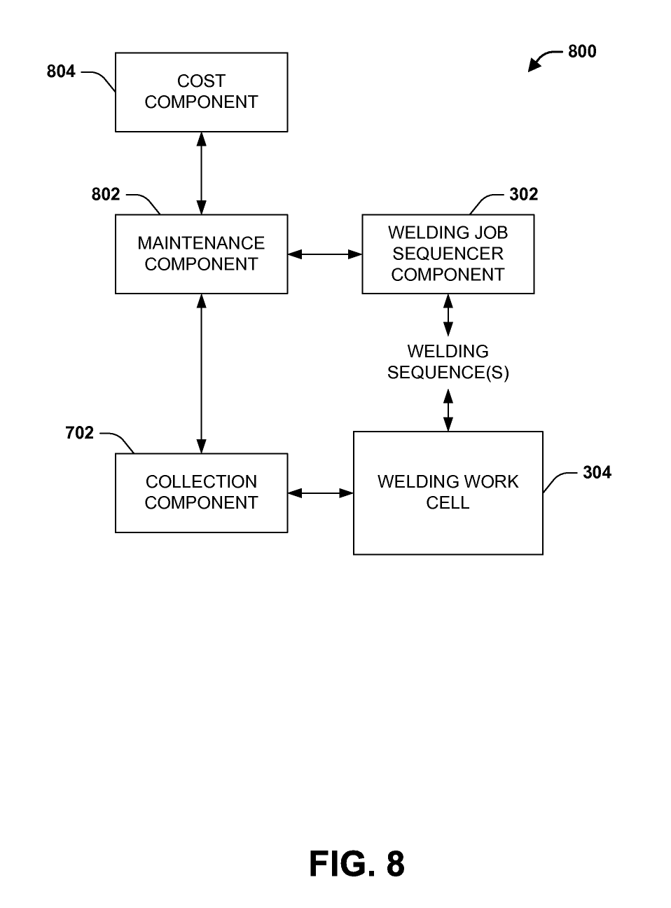

FIG. 8 illustrates system 800 that detects one or more welding parameters to implement a service on a welding equipment that performs one or more welds with a welding sequence. System 800 further includes maintenance component 802 that schedules a repair or performs a service within welding work cell 304 based on data (e.g., welding parameter, weld time, among others) collected via collection component 702. Maintenance component 802 is configured to evaluate welding parameter(s), weld time, and/or maintenance performed within welding work cell 304 in order to schedule a service or repair to provide preventative maintenance. By way of example and not limitation, maintenance component 802 can receive data related to a service or maintenance applied to welding equipment and determine a frequency or timeframe on performing such service or maintenance based on the welding parameter or weld time tracked for the welding sequence. Thus, preventative maintenance can be provided based on welding parameter(s) collected for each welding sequence so as to provide an accurate employment of a repair, a service, or a maintenance.

For instance, collection component 702 can collect repair data for a welding equipment using a welding sequence, wherein maintenance component 802 can determine a repair schedule for the welding equipment based thereon. In such examples, system 800 can create a frequency or time frame based on the collected welding parameter or weld time to schedule each repair on each welding equipment within welding work cell 304. In particular, welding sequence A can be used for a duration of time and after duration T, a maintenance procedure can be performed on a piece of welding equipment used with welding sequence A. It is to be appreciated and understood that maintenance component 802 can schedule at least one of a repair, a maintenance, a preventative maintenance, a part replacement, a safety inspection, a permit inspection, a state inspection, among others for a portion of welding work cell 304 (e.g., welding equipment, components, and the like).

By way of example and not limitation, a welding sequence can be used by welding equipment to perform one or more welds. For each welding sequence, a duration of time or an amount of use (e.g., welding sequence used X times, where X is a positive integer) can be used to schedule work on a portion of the welding equipment. In another example, a weld time can be used to schedule work on for a portion of the welding work cell 304. It is to be appreciated and understood that the scheduling can include, but is not limited to, communicating a notice, generating an alert, submitting a work order, requesting a service from an employee, requesting a service from a company, displaying a notification, among others.

System 800 further includes cost component 804 that is configured to track a monetary cost with use of a welding sequence. Monetary cost for a welding sequence relates to the amount of money that directly corresponds to creating one or more welds defined in the welding sequence. In an embodiment, cost component 804 attributes a monetary cost for the weld or the welding sequence based on welding parameter(s) data and/or weld time collected via collection component 702. In another embodiment, cost component 804 evaluates at least one of an operator wage, a consumption of materials for the weld (e.g., wire, gas, electrodes, among others), a cost for welding equipment (e.g., lease amount, purchase price, maintenance cost, power consumption, and the like), a location cost (e.g., rent amount, lease amount, purchase price, utility cost, among others), information technology (IT) cost (e.g., programming, support, and the like), or a cost associated with making a weld with the welding sequence.

Cost component 804 is configured to compare a cost between two or more operators that use the welding sequence(s). In addition, cost component 804 is configured to compare an actual cost determined with a target cost for one or more operators, one or more welding sequences, or a combination thereof. In an embodiment, an operator within a welding environment can be authorized to utilize a welding sequence based on calculations and/or determinations of cost component 804. In other words, an operator that is more cost efficient with a first welding sequence in comparison to a second welding sequence can be assigned to welds for the first welding sequence. In another embodiment, cost component 804 can determine a percentage of profit created per operator with a welding sequence. In general, cost component 804 can be utilized to assign operators to welding sequences, evaluate performance of an operator, identify cost inflation for a welding sequence or workpiece, identify wage adjustments, among others.

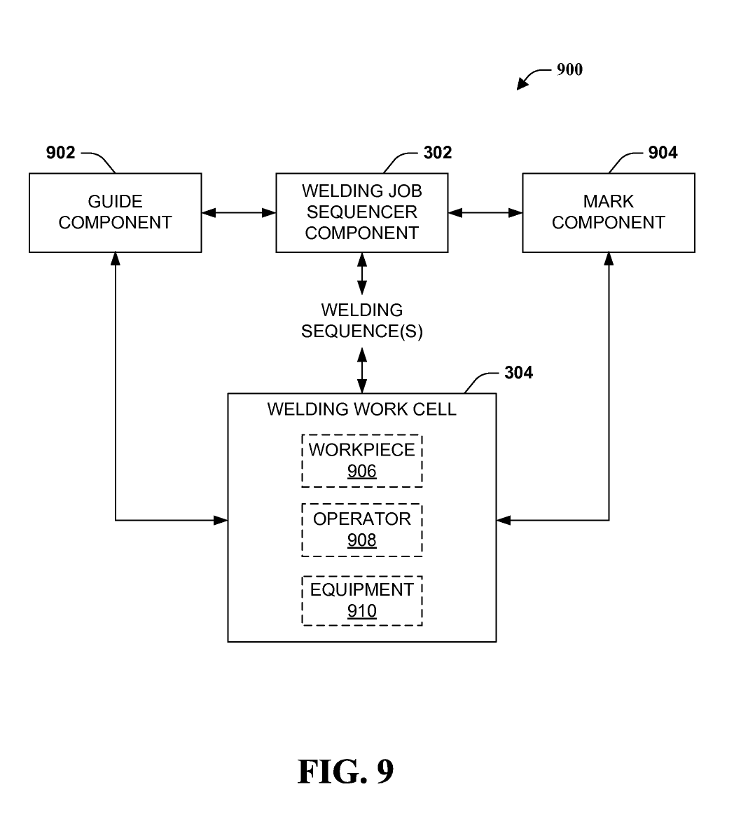

FIG. 9 illustrates system 900 that displays media to assist an operator in performing one or more welds with a welding sequence. System 900 includes guide component 902 that is configured to display a portion of media captured from the first weld or the second weld for a subsequent weld performed with the welding sequence, wherein the portion of media is at least one of audio, video, image, among others. For instance, guide component 902 provides media (e.g., a hologram or image) that is from a previous weld performed with a welding sequence to demonstrate to the operator his or her performance in comparison to such previous weld. Guide component 902 enables the operator to gauge his or her on performance using a welding sequence and/or performing one type of weld more than once. For example, welding sequence A can include welds W1 and W2 performed one after the other. On a first run, guide component 902 can capture media for W1 and W2. On a second run, guide component 902 renders media for W1 (captured during the first run) to give the operator a gauge on his or her performance in comparison to the W1 weld made during the first run. Moreover, gauge component 902 renders media for W2 (captured during first run) to give the operator a gauge on his or her performance in comparison to the W2 weld made during the first run. In another example, guide component 902 can render media associated with a model weld for the welding sequence, wherein the model weld is indicated as a optimum or preferred weld (e.g., without defects, issues, problems, best performance, optimum pace, among others). It is to be appreciated that guide component 902 can change from rendering model weld information or previous weld information. Furthermore, guide component 902 can render media for a weld illustrating previous performance for any operator using any welding sequence.

In an example, the portion of media can be related to a weld (e.g., physical appearance), a welding torch (e.g., orientation, location, etc.), workpiece 906 (e.g., fixture location, etc.), a body part of operator 908 (e.g., hand location, body location, among others), a location of equipment 910 (e.g., welding equipment, equipment of operator 908, among others), or a combination thereof. In general, a portion of media is presented to operator 908 to facilitate operator 908 performing a weld with the welding sequence. Guide component 902 is further configured to communicate the portion of media to operator 908. By way of example and not limitation, the portion of media can be communicated via a device (e.g., smartphone, speaker, display, handheld, portable gaming device, tablet, laptop, monitor, television, among others). Moreover, the portion of media can be displayed onto or using equipment 910 of operator 908. By way of example and not limitation, equipment 910 of operator 908 can be a helmet, a visor, a pair of glasses, a glove, an apron, a jacket, a welding sleeve, an identification badge of the operator, an earpiece, a pair of headphones, an ear plug, a headband, a bandana, a watch, an item of jewelry (e.g., ring, necklace, bracelet, among others), and the like.

In an embodiment, guide component 902 can display a hologram (e.g., holographic images, 3D images, 3D video, holographic video, and the like) onto at least one of an equipment 910 of operator 908, workpiece, 906 or a surface that workpiece 906 is situated. The hologram can be a “ghosting” that shows a performance of a weld with the welding sequence so as to communicate or show to operator 908 the positions (e.g., operator physical location, fixture location, welding torch angle/position, workpiece location, etc.), motions (e.g., welding torch motions to create weld, and the like), rate (e.g., speed of which to make the weld, and the like), weld dimensions (e.g., weld size, look of weld, and the like), performance, among others.

System 900 further includes mark component 904 that is configured to integrate an identification or data to workpiece 906 to convey information about welding operations used thereon. The identification or data can be, but is not limited to, a number, a letter, a job number, a welding sequence identification, a serial number, a part number, a word, a client name, a quality assurance reference (e.g., a pass, a fail, a score from weld score component, check point data, among others), and the like. Mark component 904 can integrate an identification to workpiece 906 with a label, a sticker, an etching, an engraving, an affixed plate, a stamp, an engraving, a Quick Response (QR) code, a barcode, a Radio Frequency Identification (RFID) tag, a Near Field Communication (NFC) device, among others. It is to be appreciated that the integration can be incorporated into workpiece 906, affixed onto workpiece 906, attached to workpiece 906, or a combination thereof.

By way of example and not limitation, the identification can relate to date, time, operator identification of who created one or more welds, welding job, client, workpiece information, welding information (e.g., welding parameters, welding equipment settings, and the like), environment data (e.g., welding environment that welding sequence will be used, target welding equipment, and the like), job information (e.g., work order, client, work instructions, and the like), quality assurance information (e.g., pass, fail, score, ranking, and the like), a combination thereof, among others. Moreover, it is to be appreciated and understood that mark component 904 can integrate an identification or data to a portion of workpiece 906 to enable portions or parts of a welding sequence to be identified (e.g., information for each portion of the welding sequence(s) can be included in the identification).

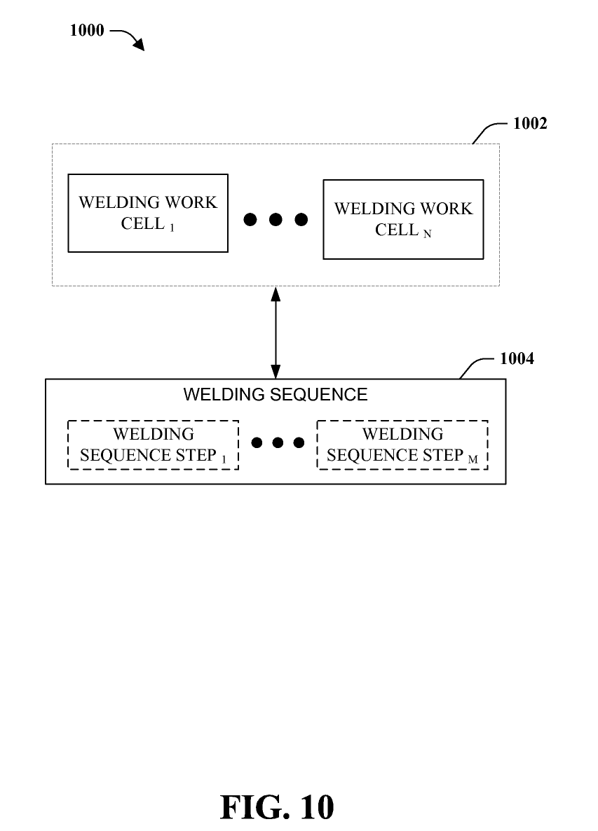

FIG. 10 illustrates system 1000 that utilizes a portion of a welding sequence in two or more welding work cells to perform one or more welds. System 1000 further includes welding environment 1002 that includes one or more welding work cells that are substantially similar to welding work cell 304 (See FIG. 3). It is to be appreciated that any suitable number of welding work cells can be within a welding environment 1002 such as welding work cell₁ to welding work celI_{N}, where N is a positive integer. As discussed above, welding sequence 1004 is utilized by welding job sequencer 302 (See FIG. 3) to perform one or more welds each having a welding schedule, wherein welding sequence automatically configures one or more settings for welding equipment without intervention from an operator. Furthermore, welding sequence 1004 includes one or more steps as discussed above. It is to be further appreciated that welding sequence 1004 includes any suitable number of welding sequence steps such as welding sequence step₁ to welding sequence step_{M}, where M is a positive integer. By way of example and not limitation, a portion of welding sequence 1004 (e.g., a step of welding sequence 1004) can be implemented at one or more welding work cells within welding environment 1002. For instance, a first welding sequence step of a welding sequence having two (2) steps can be performed at a first welding work cell and a second welding sequence step of the welding sequence can be performed at a second welding work cell. In an embodiment, an overall welding sequence can be employed for welding sequences that utilize more than one welding work cell, wherein data from each welding sequence step is communicated between each step at each welding work cell. The overall welding sequence can route a workpiece to different welding work cells, manage reworking of workpieces, aggregate information from all welding work cells that performed on the workpiece, among others.

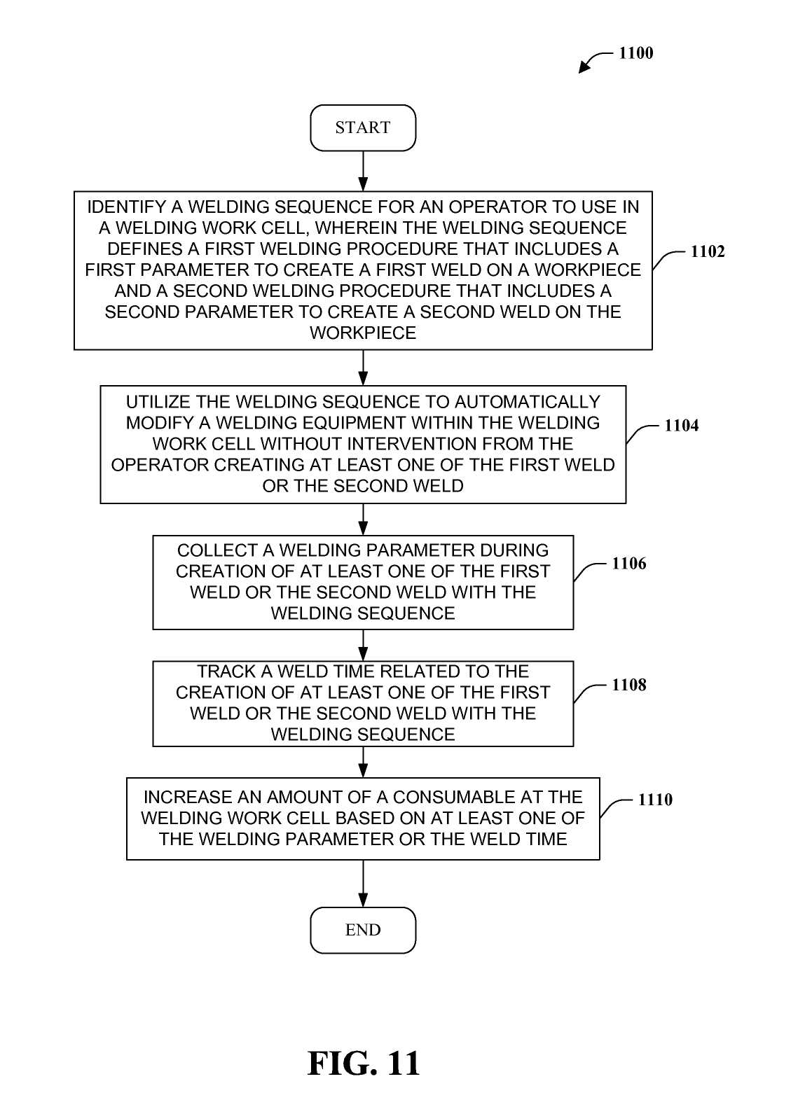

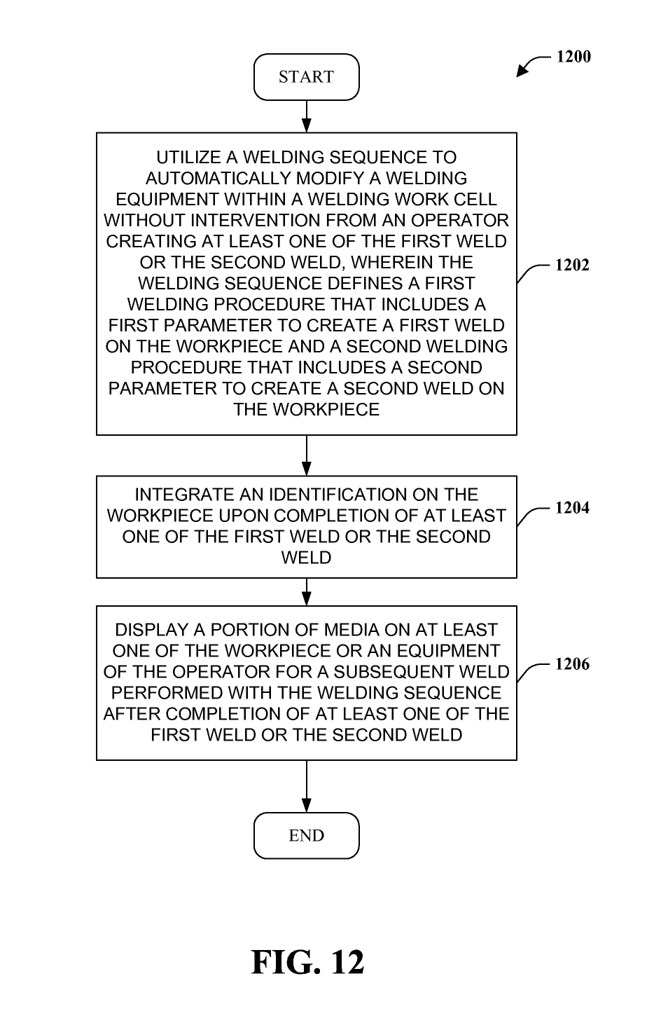

In view of the exemplary devices and elements described supra, methodologies that may be implemented in accordance with the disclosed subject matter will be better appreciated with reference to the flow charts and/or methodologies of FIGS. 11 and 12. The methodologies and/or flow diagrams are shown and described as a series of blocks, the claimed subject matter is not limited by the order of the blocks, as some blocks may occur in different orders and/or concurrently with other blocks from what is depicted and described herein. In an embodiment, a first input can be received prior to a second input (as described below). In another embodiment, a second input can be received prior to a first input. In an embodiment, the a first input and a second input can be received at substantially the same time. Moreover, not all illustrated blocks may be required to implement the methods and/or flow diagrams described hereinafter.

Sequentially, the following occurs as illustrated in the decision tree flow diagram 1100 of FIG. 11 which is a flow diagram 1100 that manages delivery and/or ordering of materials based on detecting welding parameters and/or a weld time for a welding sequence. A welding sequence is identified for an operator to use in a welding work cell, wherein the welding sequence defines a first welding procedure that includes a first parameter to create a first weld on a workpiece and a second welding procedure that includes a second parameter to create a second weld on the workpiece (reference block 1102). The welding sequence is utilized to automatically modify a welding equipment within the welding work cell without intervention from the operator creating at least one of the first weld or the second weld (reference block 1104). A welding parameter is collected during creation of at least one of the first weld or the second weld with the welding sequence (reference block 1106). A weld time related to the creation of at least one of the first weld or the second weld with the welding sequence is tracked (reference block 1108). An amount of a consumable at the welding work cell is increased based on at least one of the welding parameter or the weld time (reference block 1110).

The following occurs as illustrated in the flow diagram 1200 of FIG. 12. Flow diagram 1200 relates to integrating an identification with a workpiece assembled with a welding sequence. A welding sequence is utilized to automatically modify a welding equipment within a welding work cell without intervention from an operator creating at least one of the first weld or the second weld, wherein the welding sequence defines a first welding procedure that includes a first parameter to create a first weld on the workpiece and a second welding procedure that includes a second parameter to create a second weld on the workpiece (reference block 1202). An identification is integrated on the workpiece upon completion of at least one of the first weld or the second weld (reference block 1204). A portion of media is displayed on at least one of the workpiece or an equipment of the operator for a subsequent weld performed with the welding sequence after completion of at least one of the first weld or the second weld (reference block 1206).

The method(s) disclosed herein can further include displaying a portion of media captured from the first weld or the second weld for a subsequent weld performed with the welding sequence. Within an embodiment, the portion of media is displayed on at least one of an equipment of the operator or the workpiece and is at least one of a video, an image, a picture, a holographic image, a holographic video, a 3 dimensional (3D) image, or a 3D video. In an embodiment, the method can further provide tracking an amount of gas used with the welding sequence, an amount of electricity used with the welding sequence, and an amount of wire with the welding sequence and calculating a cost for the operator to perform at least one of the first weld or the second weld with the welding sequence.

By way of example and not limitation, welding equipment (e.g., controller for a welder power source, wire feeder, welder power source, among others) can include one or more steps related to a particular welding process for a specific workpiece, wherein a step can include a respective setting or configuration for at least one welding equipment. For instance, a first workpiece can include steps A, B, C, and D based on welding parameters desired, the welding process used, and/or the workpiece. In another example, a second workpiece can include steps B, C, A, E, and F. With the employment of a welding sequence, the controller implementing the steps for the welding process via the welder power source and/or welding equipment can be managed and/or instructed. For instance, the welding sequence can indicate at least one of the following: which steps to perform, redo a step, skip a step, pause a sequence of steps, among others. Furthermore, a controller (e.g., or other suitable component) can control one or more welder power sources, parameters, welding schedules, among others associated with one or more welding processes, wherein each welding process can have a corresponding welding sequence(s).

In an embodiment, a system can provide a weld score component that is configured to evaluate at least one of the first weld or the second weld performed on the workpiece by the operator based upon at least one of a characteristic of the first weld or the second weld or a user inspection. In another embodiment, a system can provide a check point component that is configured to monitor creation of at least one of the first weld or the second weld. the welding job sequencer component further instructs an operator of the welding work cell to assemble the workpiece with the first welding procedure and the second welding procedure having two separate welding schedules.

Within an embodiment of the system provided, the manager component can further be configured to evaluate an inventory of a consumable and compare the inventory to the estimation of consumable depletion. For instance, the manager component is further configured to communicate an order to purchase additional consumables based on the comparison. In another instance, the manager component is further configured to communicate a delivery of a consumable to the welding work cell from the inventory based on the comparison.

Within an embodiment of the system provided, the collect component is further configured to collect a welding parameter for at least one of the first weld or the second weld, wherein the collection component corresponds the welding parameter to the identified welding sequence and at least one of the first weld or the second weld. For instance, the manager component is further configured to calculate the estimation of consumable depletion based on the welding parameter collected. In an embodiment, the system can provide a maintenance component that is configured to schedule a service on a welding equipment based upon at least one of the collected welding parameter or the weld time, wherein the welding equipment is serviced to prevent the welding equipment from performing the first weld or the second weld with the welding sequence. For instance, the service is at least one of a replenishment of a consumable or a tip replacement for a welding torch that performs the first weld or the second weld.

In an example, the system can provide that the first weld created with the welding sequence is performed at the welding work cell and the second weld is created with the welding sequence is created at an additional welding work cell.

In an embodiment, the system can provide a guide component that is configured to display a portion of media captured from the first weld or the second weld for a subsequent weld performed with the welding sequence. For instance, the guide component displays the portion of media on at least one of an equipment of the operator or the workpiece as at least one of a video, a portion of audio, a 3 dimensional (3D) image, a hologram, or an image. Within an embodiment of a system, a mark component can be provided that is configured to integrate an identification onto the workpiece after the welding sequence performs at least one of the first weld or the second weld.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welder system, comprising:
a welding job sequencer component that is configured to identify a welding sequence for a welding work cell, wherein the welding sequence defines at least a parameter and a welding schedule for a first welding procedure to create a first weld on a workpiece and a second welding procedure to create a second weld on the workpiece;
the welding job sequencer component is further configured to utilize the welding sequence in the welding work cell to automatically configure welding equipment to perform the first welding procedure and the second welding procedure on the workpiece without intervention from the operator; and
a collection component that is configured to track a weld time for at least one of the first weld or the second weld performed with the welding sequence; and
a manager component that is configured to ascertain an estimation of consumable depletion based on the weld time for the welding sequence used to perform the first weld or the second weld.

2. The welder system of claim 1, further comprising a weld score component that is configured to evaluate at least one of the first weld or the second weld performed on the workpiece by the operator based upon at least one of a characteristic of the first weld or the second weld or a user inspection.

3. The welder system of claim 1, further comprising a check point component that is configured to monitor creation of at least one of the first weld or the second weld.

4. The welder system of claim 1, wherein the welding job sequencer component further instructs an operator of the welding work cell to assemble the workpiece with the first welding procedure and the second welding procedure having two separate welding schedules.

5. The welder system of claim 1, wherein the manager component is further configured to evaluate an inventory of a consumable and compare the inventory to the estimation of consumable depletion.

6. The welder system of claim 5, wherein the manager component is further configured to communicate an order to purchase additional consumables based on the comparison.

7. The welder system of claim 5, wherein the manager component is further configured to communicate a delivery of a consumable to the welding work cell from the inventory based on the comparison.

8. The welder system of claim 1, wherein the collect component is further configured to collect a welding parameter for at least one of the first weld or the second weld, wherein the collection component corresponds the welding parameter to the identified welding sequence and at least one of the first weld or the second weld.

9. The welder system of claim 8, wherein the manager component is further configured to calculate the estimation of consumable depletion based on the welding parameter collected.

10. The welder system of claim 8, further comprising a maintenance component that is configured to schedule a service on a welding equipment based upon at least one of the collected welding parameter or the weld time, wherein the welding equipment is serviced to prevent the welding equipment from performing the first weld or the second weld with the welding sequence.

11. The welder system of claim 10, wherein the service is at least one of a replenishment of a consumable or a tip replacement for a welding torch that performs the first weld or the second weld.

12. The welder system of claim 1, wherein the first weld created with the welding sequence is performed at the welding work cell and the second weld is created with the welding sequence is created at an additional welding work cell.

13. The welder system of claim 1, further comprising a guide component that is configured to display a portion of media captured from the first weld or the second weld for a subsequent weld performed with the welding sequence.

14. The welder system of claim 12, wherein the guide component displays the portion of media on at least one of an equipment of the operator or the workpiece as at least one of a video, a portion of audio, a 3 dimensional (3D) image, a hologram, or an image.

15. The welder system of claim 1, further comprising a mark component that is configured to integrate an identification onto the workpiece after the welding sequence performs at least one of the first weld or the second weld.

16. A method of welding in a welding work cell, comprising:
identifying a welding sequence for an operator to use in a welding work cell, wherein the welding sequence defines a first welding procedure that includes a first parameter to create a first weld on a workpiece and a second welding procedure that includes a second parameter to create a second weld on the workpiece;
utilizing the welding sequence to automatically modify a welding equipment within the welding work cell without intervention from the operator creating at least one of the first weld or the second weld;
collecting a welding parameter during creation of at least one of the first weld or the second weld with the welding sequence;
tracking a weld time related to the creation of at least one of the first weld or the second weld with the welding sequence; and
increasing an amount of a consumable at the welding work cell based on at least one of the welding parameter or the weld time.

17. The method of claim 16, further comprising displaying a portion of media captured from the first weld or the second weld for a subsequent weld performed with the welding sequence.

18. The method of claim 17, wherein the portion of media is displayed on at least one of an equipment of the operator or the workpiece and is at least one of a video, an image, a picture, a holographic image, a holographic video, a 3 dimensional (3D) image, or a 3D video.

19. The method of claim 16, further comprising:
tracking an amount of gas used with the welding sequence, an amount of electricity used with the welding sequence, and an amount of wire with the welding sequence; and
calculating a cost for the operator to perform at least one of the first weld or the second weld with the welding sequence.

20. A welder system, comprising:
means for identifying a welding sequence for an operator to use in a welding work cell, wherein the welding sequence defines a first welding procedure that includes a first parameter to create a first weld on a workpiece and a second welding procedure that includes a second parameter to create a second weld on the workpiece;
means for utilizing the welding sequence to automatically modify a welding equipment within the welding work cell without intervention from the operator creating at least one of the first weld or the second weld;
means for collecting a welding parameter during creation of at least one of the first weld or the second weld with the welding sequence;
means for tracking a weld time related to the creation of at least one of the first weld or the second weld with the welding sequence;
means for increasing an amount of a consumable at the welding work cell based on at least one of the welding parameter or the weld time;
means for calculating a cost based on the weld time for use of the welding sequence; and
means for managing an inventory of consumables based on the cost.
